(19) United States
(12) Patent Application Publication
(10) Pub. No.: US 2005/0167414 A1
(43) Pub. Date: Aug. 4, 2005

(54) Cooking device with a thick film resistive element heater

(76) Inventors: Po-Chun Kuo, Tainan Hsien (TW); Yeh-Ping Lin, Yung-Kang City (TW)

Correspondence Address: LADAS & PARRY LLP, 224 SOUTH MICHIGAN AVENUE, SUITE 1600, CHICAGO, IL, 60604, US

(21) Appl. No.: 10/768,255

(22) Filed: Jan. 30, 2004

(51) Int. Cl. H05B 3/68

(52) U.S. Cl. 219/446.1

(57) ABSTRACT

A cooking device includes a cooking plate having an upper surface that is adapted to receive food thereon, and a bottom surface that is opposite to the upper surface, and a thick film heater formed on the bottom surface of the cooking plate. The thick film heater includes a first insulation layer bonded to the bottom surface of the cooking plate, a second insulation layer bonded to the first insulation layer, and a thick film resistive element interposed between and bonded to the first and second insulation layers.

### BACKGROUND OF THE INVENTION

1. Field of the Invention

This invention relates to a cooking device, more particularly to a cooking device with a thick film resistive element heater.

2. Description of the Related Art

FIG. 1 illustrates schematically and fragmentarily a conventional cooking device 1 that includes a cooking plate 11 with a conductive heater 12 mounted on a bottom surface 111 of the cooking plate 11 for cooking food 13 disposed on top of the cooking plate 11. Hollow protrusions 14 are formed on the bottom surface 111 of the cooking plate 11 to retain the conductive heater 12 on the cooking plate 11 during forging of the cooking plate 11. The aforesaid conventional cooking device 1 is disadvantageous in that the presence of the hollow protrusions 14 on the cooking plate 11 complicates the design and assembly of other components of the cooking device 1.

### SUMMARY OF THE INVENTION

Therefore, the object of the present invention is to provide a cooking device with a thick film resistive element heater that is capable of overcoming the aforesaid drawbacks of the prior art.

According to the present invention, there is provided a cooking device that includes: a cooking plate having an upper surface that is adapted to receive food thereon, and a bottom surface that is opposite to the upper surface; and a thick film heater formed on the bottom surface of the cooking plate.

### BRIEF DESCRIPTION OF THE DRAWINGS

In drawings which illustrate embodiments of the invention,

FIG. 1 is a schematic fragmentary sectional view of a cooking plate of a conventional cooking device;

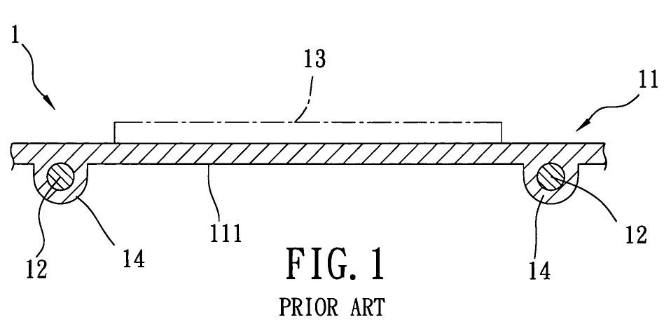

FIG. 2 is an exploded perspective view of the first preferred embodiment of a cooking device according to the present invention;

FIG. 3 is a fragmentary sectional view of a cooking plate of the cooking device of the first embodiment;

FIG. 4 is an exploded perspective view of the second preferred embodiment of the cooking device according to the present invention;

FIG. 5 is a fragmentary sectional view of the cooking device of the second embodiment; and

FIG. 6 is a bottom view of a heating plate of the cooking device of the second embodiment.

### DETAILED DESCRIPTION OF THE PREFERRED EMBODIMENTS

For the sake of brevity, like elements are denoted by the same reference numerals throughout the disclosure.

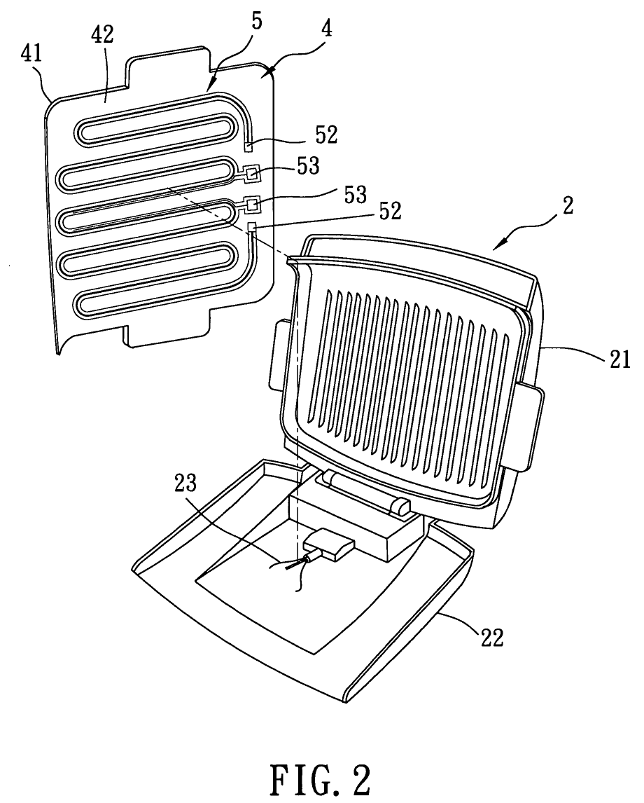

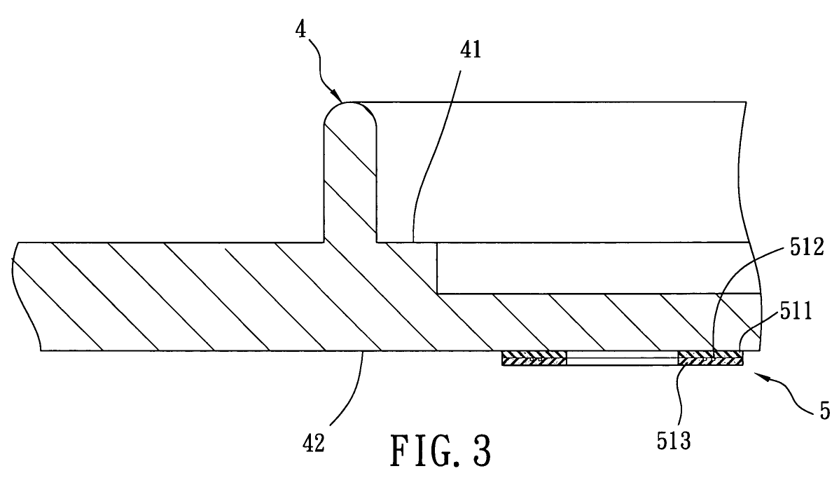

FIGS. 2 and 3 illustrate the first preferred embodiment of a cooking device according to the present invention. The cooking device includes: a housing 2 having a base 22 and a cover 21 pivoted to the base 22, a cooking plate 4 disposed in the housing 2, mounted on the base 22, and having an upper surface 41 that is adapted to receive food thereon, and a bottom surface 42 that is opposite to the upper surface 41; and a thick film heater 5 formed on the bottom surface 42 of the cooking plate 4. The base 22 is provided with a set of power and signal wires 23 for electrically connecting the thick film heater 5 to a power source (not shown) and a controller (not shown).

In this embodiment, the thick film heater 5 extends along a tortuous contour, has a thickness ranging from 5 to 10 μm, and includes a first insulation layer 511 bonded to the bottom surface 42 of the cooking plate 4, a second insulation layer 513 bonded to the first insulation layer 511, and a thick film resistive element 512 interposed between and bonded to the first and second insulation layers 511, 513. The first and second insulation layers 511, 513 and the thick film resistive element 512 are formed on the bottom surface 42 of the cooking plate 4 by silkscreen printing. Resistive terminals 52 are electrically connected to two opposite ends of the thick film resistive element 512 and the power wires 23. In addition, temperature terminals 53 are disposed adjacent to the thick film resistive element 512 and the signal wires 23.

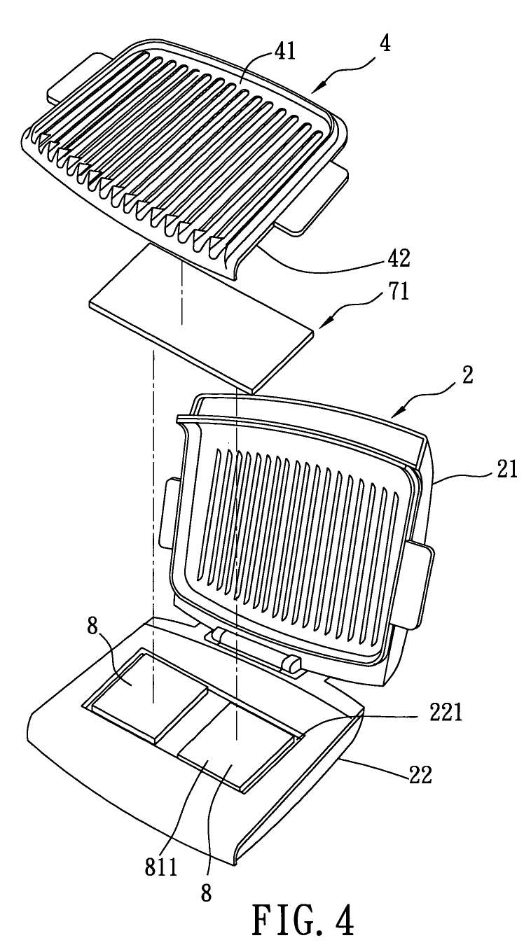

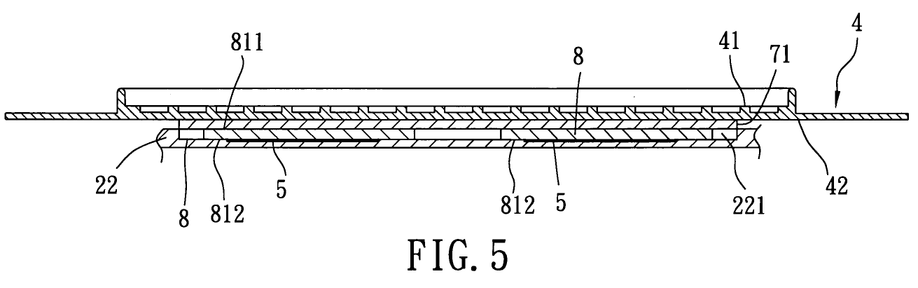

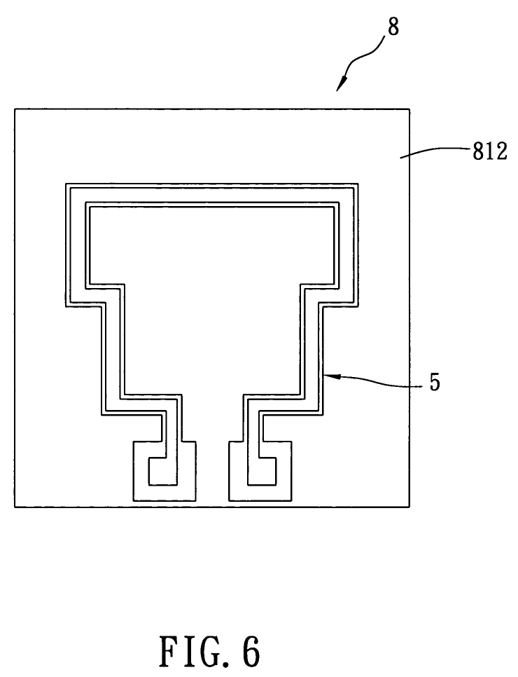

FIGS. 4 to 6 illustrate the second preferred embodiment of the cooking device according to the present invention. The cooking device of this embodiment is similar to the previous embodiment, except that two heating plates 8 are provided for heating purposes. Note that only one heating plate 8 may be installed for smaller cooking devices.

Each of the heating plates 8 is mounted in a retaining recess 221 in the base 22, and has an upper surface 811 that is connected to the bottom surface 42 of the cooking plate 4, and a bottom surface 812 that is opposite to the upper surface 811 of the heating plate 8 and that is formed with the thick film heater 5, which has a contour different from that of the previous embodiment.

Preferably, a heat conducting plate 71, which is made from aluminum, is interposed between and contacts the bottom surface 42 of the cooking plate 4 and the upper surface 811 of the heating plate 8 for enhancing heat conduction to the cooking plate 4 and for permitting use of a general iron material or alloy material for making the base 22 and the heating plate 8.

By virtue of the thick film heater 5, the profile of the cooking device of this invention can be reduced as compared to that of the prior art, and the aforesaid drawbacks associated with the prior art can be eliminated.

With the invention thus explained, it is apparent that various modifications and variations can be made without departing from the spirit of the present invention.

1. A cooking device, comprising:
a cooking plate having an upper surface that is adapted to receive food thereon, and a bottom surface that is opposite to said upper surface; and
a thick film heater formed on said bottom surface of said cooking plate.

2. The cooking device of claim 1, wherein said thick film heater includes a first insulation layer bonded to said bottom surface of said cooking plate, a second insulation layer bonded to said first insulation layer, and a thick film resistive element interposed between and bonded to said first and second insulation layers, said first and second insulation layers and said thick film resistive element being formed on said bottom surface of said cooking plate by silkscreen printing.

3. The cooking device of claim 1, wherein said thick film heater has a thickness ranging from 5 to 10 μm.

4. A cooking device, comprising:
a cooking plate having an upper surface that is adapted to receive food thereon, and a bottom surface that is opposite to said upper surface;
at least a heating plate having an upper surface that is connected to said bottom surface of said cooking plate, and a bottom surface that is opposite to said upper surface of said heating plate; and
a thick film heater formed on said bottom surface of said heating plate.

5. The cooking device of claim 4, wherein said thick film heater includes a first insulation layer bonded to said bottom surface of said heating plate, a second insulation layer bonded to said first insulation layer, and a thick film resistive element interposed between and bonded to said first and second insulation layers, said first and second insulation layers and said thick film resistive element being formed on said bottom surface of said heating plate by silkscreen printing.

6. The cooking device of claim 4, wherein said thick film heater has a thickness ranging from 5 to 10 μm.

7. The cooking device of claim 4, further comprising at least a heat conducting plate interposed between and contacting said bottom surface of said cooking plate and said upper surface of said heating plate.

8. The cooking device of claim 7, wherein said heat conducting plate is made from aluminum.

9. The cooking device of claim 4, further comprising a base that is formed with a retaining recess therein, said heating plate being mounted in said retaining recess.
